(19) United States
(12) Patent Application Publication
(10) Pub. No.: US 2019/0014168 A1
(43) Pub. Date: Jan. 10, 2019

(54) Computer Network using Multiple Connection Pathways

(71) Applicant: POINTR DATA INC., San Jose, CA (US)

(72) Inventors: Nurettin Burcak Beser, Palo Alto, CA (US); Saran Saund, Mountain View, CA (US)

(21) Appl. No.: 16/029,360

(22) Filed: Jul. 6, 2018

Related U.S. Application Data
(60) Provisional application No. 62/529,897, filed on Jul. 7, 2017.

(51) Int. Cl. H04L 29/08; H04L 29/06; G06F 13/42

(52) U.S. Cl. CPC H04L 67/10; H04L 69/16; G06F 2213/0042; G06F 2213/0026; G06F 13/4282

(57) ABSTRACT

A computer network having multiple communication channels includes a first computer; a second computer in bi-directional communication with the first computer through a primary TCP/IP communication channel and through a non-TCP/IP communication channel; wherein the first computer and the second computer transmit a first data set and first instructions along the primary TCP/IP communication channel; and wherein the first computer and the second computer transmit a second data set and second instructions along the non-TCP/IP communication channel.

### CROSS-REFERENCE TO RELATED APPLICATIONS

This application is a non-provisional patent application of, and claims priority to, U.S. Provisional Pat. App. No. 62/529,897 filed Jul. 7, 2017 and entitled “HARDWARE ARCHITECTURE FOR EFFICIENT NEURAL NETWORK CLUSTER PROCESSING,” which is incorporated herein by reference in its entirety.

### FIELD

In general, this disclosure relates to multi-node computers that require communicating large amounts of data frequently, and, more specifically, to increasing bandwidth available for communication, and/or decreasing processing delays, between applications that run on the nodes of such computer systems.

### BACKGROUND

In computer communications, communication protocols are systems of rules that allow two or more computer components to transmit information (e.g., data sets and instructions) between themselves. Communication protocols are implemented in hardware, software, combinations of hardware and software, and/or other. Multiple communication protocols are often used together—including applying to different aspects of a single communication—and groups of protocols designed to work together are called communications protocol suites.

Depending on the communication protocol suite, computer communications can be connection-based or connection-less. In connection-based computer communications, senders transmit information to receivers after establishing a prior connection between the sender and the receiver, signaling the sender is ready to send, and the receiver is ready to receive, the information transmittal. On the other hand, in connection-less computer communications, senders transmit information to receivers without establishing a prior connection between the sender and the receiver. In addition, connection-less computer communications allow senders to send information to multiple receivers at a single time.

A transmission control protocol (TCP) ensures connectivity between senders and receivers, handling handshaking and protocol details there between. As such, TCP is a connection-based communication protocol. Oftentimes, TCP is complemented by an internet protocol (IP), which transmits packets of data from senders to receivers based on IP addresses in packet headers. As such, IP is a connection-less communication protocol. Commonly used together, a protocol suite using both is commonly called TCP/IP, and TCP/IP is part of a primary communications protocol suite used in Internet transmissions throughout the world, usually over the physical Ethernet, local area networks (LANs), metropolitan area networks (MANs), wide area networks (WANs), and/or with wireless connectivity too. TCP exists at a transport layer of an Internet protocol suite (IPS), and IP exists at an internet layer of the IPS, by which the protocols work together.

In many clustered computer systems, applications communicate using TCP/IP communication stacks, which use interconnections among link layer technologies of, for example, attached resource computer networks (ARCNET), asynchronous transfer modes (ATMs), the Ethernet, fiber distributed data interfaces (FDDIs), token rings, etc. In clustered programming, where numerous independent computers (e.g., nodes) communicate, increasing the bandwidth available for communication and/or decreasing processing delays improve cluster performance.

The TCP/IP stack that is currently used with many intra-cluster communications frequently delays the communication, and various technologies increase bandwidth and/or decrease processing delays in various computer cluster technologies. Peripheral component interconnect express (PCIe) is an example of such a technology. However, even though PCIe has been used to communicate within computers (e.g., nodes), PCIe requires cluster application software to be specifically written for these kinds of technologies.

Cluster-based applications are commonly used in areas such as artificial intelligence and genetic research, and the software that is currently written for such systems often use the TCP/IP stack to communicate. Most of the cluster software programs are complicated, however, and updating solutions for applications that are not TCP/IP based often requires rewriting the software. Even when it is feasible to update the software, it often remains different than that of the commonly updated open source software base, such that open source updates are not readily reflected in the updated software base.

### SUMMARY

In various embodiments, a computer network having multiple communication channels includes a first computer; a second computer in bi-directional communication with the first computer through a primary TCP/IP communication channel and through a non-TCP/IP communication channel; wherein the first computer and the second computer transmit a first data set and first instructions along the primary TCP/IP communication channel; and wherein the first computer and the second computer transmit a second data set and second instructions along the non-TCP/IP communication channel.

In various embodiments: the first computer and the second computer simultaneously transmit the first data set and the first instructions along the primary TCP/IP communication channel and the second data set and the second instructions along the non-TCP/IP communication channel; transmission along the non-TCP/IP communication channel is block-oriented; the non-TCP/IP communication channel comprises a universal serial bus (USB) connection; the non-TCP/IP communication channel comprises a peripheral component interconnect express (PCIe) connection; transmission along the non-TCP/IP communication channel comprises a higher throughput than transmission along the primary TCP/IP communication channel; transmission along the non-TCP/IP communication channel comprises a lower latency than transmission along the primary TCP/IP communication channel; at least one of the first computer and the second computer utilize direct memory access over the non-TCP/IP communication channel; transmission along at least one of the primary TCP/IP communication channel and the non-TCP/IP communication channel is unicast; transmission along the non-TCP/IP communication channel is broadcast; and/or transmission along the non-TCP/IP communication channel is multicast.

In various embodiments, a computer-implemented method of processing information in computer network having multiple communication channels includes receiving a data set and instructions for transmission between a first computer and a second computer; determining whether to transmit the data set and instructions between a first computer and a second computer along a primary TCP/IP communication channel or a non-TCP/IP communication channel; and transmitting the data set and instructions between the first computer and the second computer along the primary TCP/IP communication channel or the non-TCP/IP communication channel in accordance with the determination.

In various embodiments: transmitting the data set and instructions between the first computer and the second computer further comprises transmitting the data set and instructions between the first computer and the second computer along the primary TCP/IP communication channel and the non-TCP/IP communication channel simultaneously; communication along the non-TCP/IP communication channel is block-oriented; the non-TCP/IP communication channel comprises a universal serial bus (USB) connection; the non-TCP/IP communication channel comprises a periphery component interconnect express (PCIe) connection; and/or the method further includes utilizing direct memory access at the first computer or second computer over the non-TCP/IP communication channel.

In various embodiments, a non-transitory computer-readable medium embodies program code executable in at least one computing device, the program code, when executed by the at least one computing device, being configured to cause the at least one computing device to at least: receive a data set and instructions for transmission between a first computer and a second computer; determine whether to transmit the data set and instructions between the first computer and the second computer along a primary TCP/IP communication channel or along a non-TCP/IP communication channel; and transmit the data set and instructions between the first computer and the second computer along the primary TCP/IP communication channel or the non-TCP/IP communication channel in accordance with the determination.

In various embodiments: the programming code is further configured to transmit the data set and the instructions between the first computer and the second computer along the primary TCP/IP communication channel and the non-TCP/IP communication channel simultaneously; and/or the non-TCP/IP communication channel comprises at least one of universal serial bus (USB) connection and a periphery component interconnect express (PCIe) connection.

### BRIEF DESCRIPTION OF THE DRAWINGS

The accompanying drawings illustrate various embodiments employing the principles described herein and are a part of the specification. The illustrated embodiments are meant for description only, and they do not limit the scope of the claims, and in which:

FIG. 1 is a representative, simplified illustration of a computer network having multiple communication channels, in various embodiments;

FIG. 2 is a representative, simplified illustration of computer componentry suitable for use with the computer network of FIG. 1, in various embodiments; and

FIG. 3 is a representative, simplified illustration of a processing method suitable for use with the computer network of FIG. 1, in various embodiments.

### DETAILED DESCRIPTION

This detailed description of exemplary embodiments references the accompanying drawings, which show exemplary embodiments by way of illustration. While these exemplary embodiments are described in sufficient detail to enable those skilled in the art to practice this disclosure, it should be understood that other embodiments may be realized and that logical changes and adaptations in design and construction may be made in accordance with this disclosure and the teachings herein described without departing from the scope and spirit hereof. Thus, this detailed description is presented for purposes of illustration only and not of limitation.

In accordance with various aspects of this disclosure, systems and methods are described for processing data sets and/or instructions in a computer network along multiple pathways, in various embodiments.

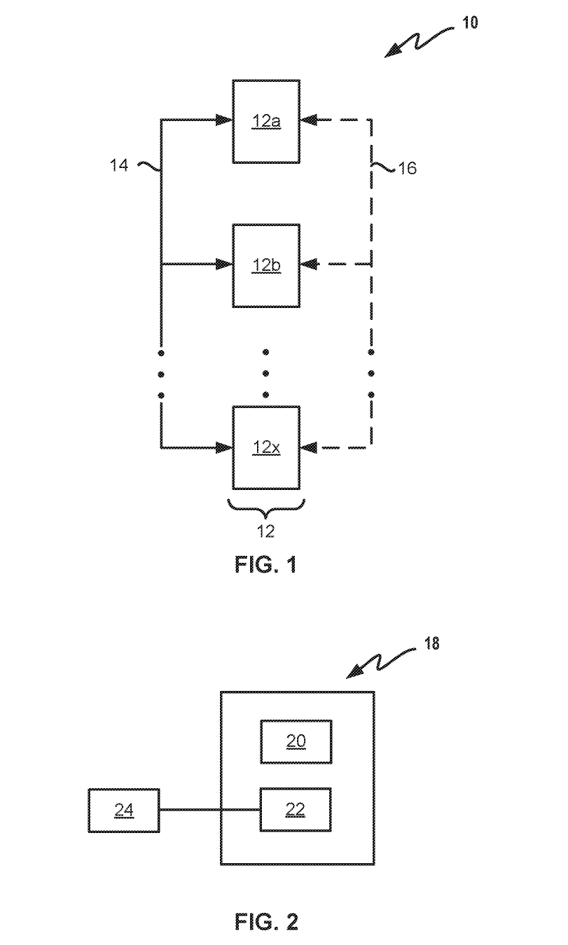

Referring now to FIG. 1, a computer network 10 comprises a first computer 12a in bi-directional communication with a second computer 12b, as well as, optionally, any number of additional computers 12x, in various embodiments. In various embodiments, the first computer 12a is in communication with the second computer 12b via a primary TCP/IP communication channel 14 and/or other packet-based communication channel and via a non-TCP/IP communication channel 16 and/or non-other packet-based communication channel.

In various embodiments, the computers 12 are configured for graphic processing, neural network processing, genome processing—e.g., applications for which distributed processing increases performance of the computer network 10 through clustered (e.g., shared) processing capabilities, etc.

In various embodiments, various information (e.g., data sets and/or instructions) is optimized for transfer along the primary TCP/IP communication channel 14 or along the non-TCP/IP communication channel 16.

In various embodiments, the primary TCP/IP communication channel 14 comprises a fast Ethernet connection. In various embodiments, the primary TCP/IP communication channel 14 comprises a packet based communication channel.

In various embodiments, the non-TCP/IP communication channel 16 comprises a high bandwidth communication connection, such as a universal serial bus (USB) connection or a peripheral component interconnect express (PCIe) connection. In various embodiments, the non-TCP/IP communication channel 16 comprises a non-packet based communication channel.

In various embodiments, information transmitted along the primary TCP/IP communication channel 14 and/or the non-TCP/IP communication channel 16 is unicast between the first computer 12a and the second computer 12b, for example. In a unicast transmission, the first computer 12a, for example, is a single sender, and the second computer 12b, for example, is a single receiver. Unicast (i.e., one-to-one) transmissions are useful when the first computer 12a and the second computer 12b, for example, seek unidirectional or bidirectional communication therebetween. If the first computer 12a seeks to send an identical unicast message to more than one of the computers 12, it does so, for example, serially and/or sequentially along the primary TCP/IP communication channel 14 and/or along the non-TCP/IP communication channel 16, in various embodiments. In various embodiments, unicast transfers use ftp, http, smtp, telenet, etc. applications, which use the transmission control protocol (TCP) at the transport layer of the internet protocol suite (IPS).

In various embodiments, information transmitted along the non-TCP/IP communication channel 16 is broadcast or multicast between the first computer 12a and the second computer 12b, as well as, optionally, to any number of additional computers 12, in various embodiments.

In a broadcast transmission, the first computer 12a, for example, is a single sender, and all other computers 12 within the computer network 10 are the receivers. Broadcast (i.e., one-to-all) transmissions are useful when the first computer 12a, for example, seeks unidirectional or bidirectional communication with all of the plurality of computers 12 of the computer network 10 simultaneously. For example, if the first computer 12a seeks to send a broadcast message to all of the plurality of computers 12 at a single time and using a single transmission, it does so, for example, by broadcasting a signal transmission along the non-TCP/IP communication channel 16, in various embodiments. In various embodiments, broadcasting is an effective transmission protocol, although it requires a significant amount of bandwidth from the computer network 10.

In a multicast transmission, the first computer 12a, for example, is a single sender, and various ones of the other computers 12 within the computer network 10 are the receivers. Multicast (i.e., one-to-several and/or one-to-many) transmissions are useful when the first computer 12a, for example, seeks unidirectional or bidirectional communication with specific ones of the plurality of computers 12 of the computer network 10 simultaneously. For example, if the first computer 12a seeks to send a multicast message to specific ones of the plurality of computers 12 at a single time and using a single transmission, it does so, for example, by multicasting a signal transmission along the non-TCP/IP communication channel 16, in various embodiments. In various embodiments, multicasting is an effective transmission protocol, particularly when the first computer 12a, for example, requires multiple ones of the computers 12 to receive a message at a same time, but the first computer 12a, for example, does not require the full bandwidth of a broadcast transmission, as less than all of the computers 12 need to receive that particular message.

Referring generally, unicast transmissions along the primary TCP/IP communication channel 14 use established protocols and are a predominant form of information transmission. However, they are less effective with scalable communications that need to reach more than one of the plurality of computers 12 via a simulcast (e.g., a broadcast or multicast) message that is to be received by more than one receiver. Moreover, many information transmissions are not optimized for simulcast messages to be received by multiple receivers, particularly when a unicast message is more efficient over the primary TCP/IP communication channel 14 as opposed to over the non-TCP/IP communication channel 16. Many information transmissions are also not optimized for transmission over the non-TCP/IP communication channel 16.

In this way, the computers 12 maximize signal transmission throughout the computer network 10, using the primary TCP/IP communication channel 14 when it is a most efficient way to do so, and using the non-TCP/IP communication channel 16 when it is a most efficient way to do so.

Referring generally, the computers 12 uses broadcast and/or multicast transmissions along the non-TCP/IP communication channel 16 when they seek simulcast transmissions to plural recipients.

Referring generally, transmissions over the non-TCP/IP communication channel 16 are faster and/or have more throughput than transmissions over the TCP/IP communication channel 14, particularly when the computers 12 seek multiple recipients among the plurality of computers 12.

In various embodiments, the non-TCP/IP communication channel 16 comprises a universal serial bus (USB) connection, including a USB Type-C connection.

In various embodiments, the non-TCP/IP communication channel 16 comprises a peripheral component interconnect express (PCIe) connection, which is a high speed input/output system using point-to-point serial links called lanes. Referring generally, PCIe connections connect single senders to multiple receivers at a given time (e.g., via broadcasting and/or multicasting) based on point-to-point topologies, supporting full-duplex (i.e., bi-directional) communications between senders and receivers, without internal limitations on a number of concurrent receivers. In various embodiments, PCIe connections comprise, for example, one (i.e., a single link), two, four, eight, twelve, sixteen, or thirty-two lanes, etc. In various embodiments, PCIe connections transfer data sets and/or instructions in multiple directions at a same time (aka parallelism), and to multiple recipients at a same time, thereby increasing (e.g., doubling, tripling, etc.) transfer rates within the computer network 10 of FIG. 1.

However, not all applications are optimized for PCIe transmissions, including many applications in which communications over the primary TCP/IP communication channel 14 are either preferred and/or more efficient than converting a particular application to a PCIe-compliant protocol. For example, broadcasting and/or multicasting with PCIe connections requires simulcasting support in both the first computer 12a and the second computer 12b, for example.

Referring generally, a PCIe connection comprises a layered protocol having at least a transaction layer, a data link layer, and a physical layer. In various embodiments, the physical layer comprises a network of serial interconnects. In various embodiments, the physical layer also comprises a logical sub-layer and an electrical sub-layer. In various embodiments, the logical sub-layer further comprises a physical coding sub-layer and a media access control sub-layer within a networking protocol. As such, the PCIe connection, as the non-TCP/IP communication channel 16, transfers instructions and data sets in multiple directions to multiple receivers at a same time, such as to more than one of the plurality of computers 12.

Within the computer network 10, the first computer 12a, for example, is a unicast, broadcast, and/or multicast producer endpoint device—i.e., a sender. As such, the first computer 12a, for example, originates data sets and/or instructions to be transmitted to one of more of the plurality of computers 12, such as the second computer 12b, for example. In return, at least some of the plurality of computers 12 are consumer endpoint devices—i.e., receivers. As such, various computers 12 receive data sets and/or instructions cast from other computers 12.

If the first computer 12a, for example, and the second computer 12b, for example, need fast access to a common data set and/or a common instruction, the common data set and/or common instruction is simulcast across the computer network 10 along the non-TCP/IP communication channel 16, in various embodiments.

Likewise, if the first computer 12a, for example, and the second computer 12b, for example, need fast access to a global data set and/or a global instruction, the global data set and/or global instruction is simulcast across the computer network 10 along the non-TCP/IP communication channel 16, in various embodiments.

Accordingly, via the non-TCP/IP communication channel 16, a common data set and/or common instruction and/or global data set and/or global instruction is sent throughout the computer network 10 as a simulcast message, in various embodiments. Via a single transmission, the computer network 10 thus communicates with more than one of the plurality of computers 12, in various embodiments.

If more than one of the plurality of computers 12 needs, for example, access to a universal transmission, the computer network 10 enables the universal transmission to be distributed to the plurality of computers 12 via the non-TCP/IP communication channel 16, as opposed to via the primary TCP/IP communication channel 14, in various embodiments.

In various embodiments, the first computer 12a, for example, transmits small, simple, time-independent, legacy, and/or one-off data sets and/or instructions to one of the plurality of computers 12 via the primary TCP/IP communication channel 14, as opposed to via the non-TCP/IP communication channel 16.

In various embodiments, the first computer 12a, for example, transmits large, complex, time-dependent, non-legacy, and/or collective data sets and/or instructions to more than one of the plurality of computers 12 via the non-TCP/IP communication channel 16, as opposed to via the primary TCP/IP communication channel 14.

For example, if a data set is large (e.g., over 100 MB) and/or efficiently handled by more than one of the plurality of computers 12 (e.g., requires over 3 milliseconds of processing time) and/or is repetitive, the computer network 10 enables transmitting the universal data set or instructions to the computers 12 via the non-TCP/IP communication channel 16, as opposed to via the primary TCP/IP communication channel 14, in various embodiments.

By utilizing both the primary TCP/IP communication channel 14 and the non-TCP/IP communication channel 16 simultaneously, faster processing within the computer network 10 is also enabled, in various embodiments.

In various embodiments, information transmission is determined to be optimized for transmission over the primary TCP/IP communication channel 14 or over the non-TCP/IP communication channel 16.

In various embodiments, the computers 12 utilizes the primary TCP/IP communication channel 14 to coordinate various activities of the plurality of computers 12, such as maintaining system time for time-stamp functions, coordinating processing functions, and scheduling function block processing, etc., in various embodiments.

In various embodiments, the non-TCP/IP communication channel 16 is reserved and/or used as a dedicated channel to transmit data sets to one or more of the plurality of computers 12 at a same time, such as the first computer 12a and the second computer 12b, as well as, optionally, any number of additional computers 12x, in various embodiments.

In various embodiments, the non-TCP/IP communication channel 16 is block-oriented, such that the computers 12 control and/or transmit blocks of data sets in single transmissions through the non-TCP/IP communication channel 16 at particular times.

In various embodiments, bi-directional communication is enabled between the plurality of computers 12, including along the primary TCP/IP communication channel 14 and/or along the non-TCP/IP communication channel 16, in various embodiments.

In various embodiments, separating instructions along the primary TCP/IP communication channel 14 and data sets along the non-TCP/IP communication channel 16 enables changes to be made to one without affecting the other. For example, updates to the instructions are transmitted along the primary TCP/IP communication channel 14 more quickly, in various embodiments, when removed and/or unrelated to the data sets. Likewise, updates to the data sets are transmitted along the non-TCP/IP communication channel 16 more quickly, in various embodiments, when removed and/or unrelated to the instructions. In various embodiments, updates to the data sets and instructions are sent to the plurality of computers 12 at a same time, including along the primary TCP/IP communication channel 14 and the non-TCP/IP communication channel 16 simultaneously.

In various embodiments, transfers of data sets and/or instructions along the primary TCP/IP communication channel 14 are slower than transfers of data sets and/or instructions along the non-TCP/IP communication channel 16. Accordingly, the non-TCP/IP communication channel 16 enables faster transfers than the primary TCP/IP communication channel 14 does, in various embodiments. However, many data sets and/or instructions are not optimized for transmission along the non-TCP/IP communication channel 16, and transitioning and/or translating such data sets and/or instructions may not justify the burden of doing so.

In various embodiments, transfers of data sets and/or instructions along the primary TCP/IP communication channel 14 have less throughput than transfers of data sets and/or instructions along the non-TCP/IP communication channel 16, particularly if particular communications need to be transmitted to multiple ones of the plurality of computers 12 at a same time. Accordingly, the non-TCP/IP communication channel 16 enables higher throughput than the primary TCP/IP communication channel 14 does, in various embodiments.

In various embodiments, most of the traffic through the computer network 10 occurs over the primary TCP/IP communication channel 14 as opposed to over the non-TCP/IP communication channel 16, particularly if a communication will not enhance the overall clustered performance of the computers 12 of the computer network 10.

Referring now to FIGS. 1-2, computer componentry 18, such as the first computer 12a, the second computer 12b, as well as, optionally, any number of additional computers 12c of FIG. 1, comprise one or more processors 20 operating in conjunction with one or more tangible, non-transitory memories 22 configured to implement digital or programmatic logic, in various embodiments. In various embodiments, for example, the one or more processors 20 comprise one or more of an application specific integrated circuit (ASIC), digital signal processor (DSP), field programmable gate array (FPGA), general purpose processor (GPP), microprocessor (MP), and/or other programmable logic device, discrete gate, transistor logic, or discrete hardware components, or any various combinations thereof and/or the like, and the one or more tangible, non-transitory memories 22 store instructions that are implemented by the one or more processors 20 for performing various functions, such as the systems and methods of the inventive arrangements described herein.

In various embodiments, the components and/or functionality described herein also include computer instructions, programs, and/or software that is or are embodied in one or more tangible, non-transitory computer-readable media 24 that are used by the one or more processors 20. As such, the computer-readable media 24 contains, maintains, and/or stores computer instructions, programs, and/or software that is used by the one or more processors 20, including physical media, such as, for example, magnetic, optical, and/or semiconductor media, including, for example, flash, magnetic, and/or solid-state devices. In various embodiments, one or more components described herein are implemented as components, modules, systems, and/or subsystems of a single application, as well as using one computing device and/or multiple computing devices.

In various embodiments, direct memory access (DMA) is used to transmit data sets and instructions within the one or more memories 22 to the processor 20. More specifically, when processors 20 enabled with DMA execute instructions, they do so while simultaneously reading and/or writing from the one or more memories 22. Accordingly, processors 20 enabled with DMA are called “direct” because they do not involve the processor 20 when moving data into and out of the one or more memories 22.

Referring generally, when processors 20 are enabled with DMA, the processors 20 establish descriptor tables (i.e., linked lists) in the one or more memories 22 using scatter/gather operations, in various embodiments. In various embodiments, the descriptor tables comprise, for example, sets of descriptors, each of which describes, for example, a data set's moving direction, sender address, receiver address, and, in various embodiments, a number of bytes to be transmitted. Alternatively, with non-scatter/gather block moves, the one or more memories 22 are programmed directly with DMA using single programming DMA block moves. For example, in a fly-by DMA processor 20, the processor 20 manages the data set transfer, but the data set does not pass through the processor 20 itself. Rather, the processor 20 issues the read and write commands to transfer the data sets, but the data sets do not pass through the processor 20 via the primary TCP/IP communication channel 14 or the non-TCP/IP communication channel 16 within the computer network 10 of FIG. 1.

As such, processors 20 enabled with DMA allow faster (i.e., decreased latency) access to the one or more memories 22 and/or faster peer-to-peer data set transfers from the processors 20 along the non-TCP/IP communication channel 16, in various embodiments. The processors 20 read and write directly into the one or more memories 22, and the processors 20 directly access the one or more memories 22, in various embodiments. As a result, processors 20 enabled with DMA access the one or more memories 22 independent of what the processor 20 is doing. In various embodiments, processors 20 enabled with DMA perform other instructions during read and write operations. DMA is particularly useful if a processor 20 does not keep pace with faster rates of data transfers (i.e., increased latency) within the computer network 10. DMA allows data sets to be transferred in parallel along the primary TCP/IP communication channel 14 and the non-TCP/IP communication channel 16. In this regard, processors 20 enabled with DMA are used in the distributed, parallel computing environment of the computer network 10 of FIG. 1, in various embodiments.

In various embodiments, software running on the computer network 10 is updated when it is transmitted over the non-TCP/IP communication channel 16. Accordingly, only network communications that significantly enhance the performance of the computer network 10 are subjected to the non-TCP/IP communication channel 16 instead of the primary TCP/IP communication channel 14. In various embodiments, this includes, for example, large files within the computer network 10 that overwhelm the primary TCP/IP communication channel 14 due to increased delay at the TCP/IP stack. In such instances, using the higher bandwidth and low delay of DMA over the non-TCP/IP communication channel 16 substantially improves the performance of the computer network 10, in various embodiments.

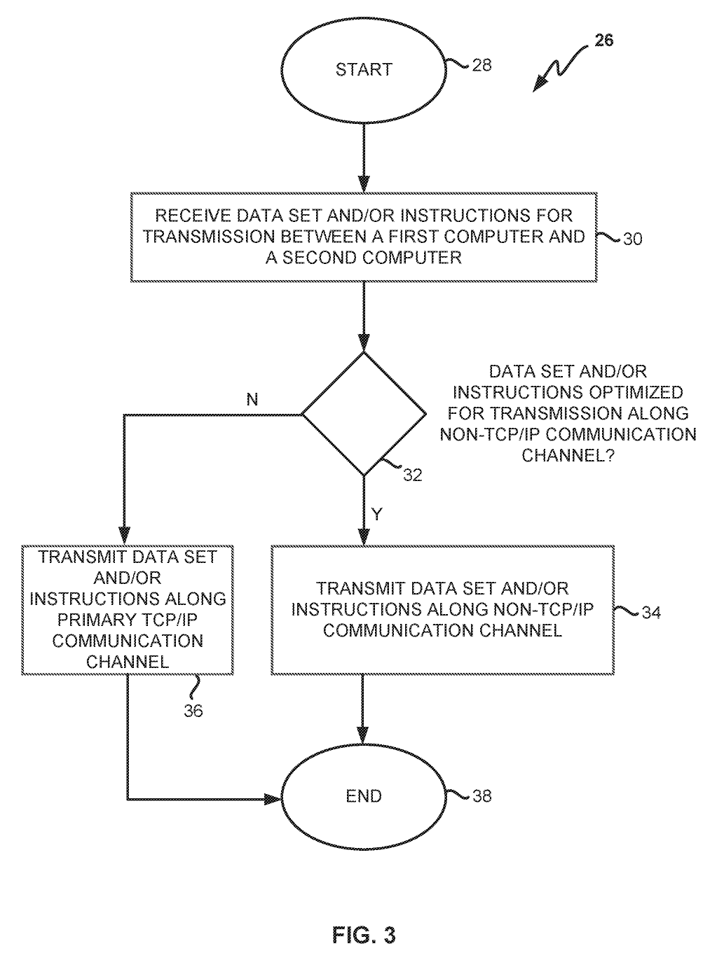

Referring now to FIG. 3, a computer-implemented method 26 begins at a step 28, after which a data set and/or instructions are received for transmission between a first computer and a second computer within a computer network at a step 30. Thereafter, control passes to a step 32, at which a determination is made as to whether the data set and/or instructions are optimized for transmission along a non-TCP/IP communication channel of the computer network. If the data set and/or instructions are optimized for transmission along the non-TCP/IP communication channel of the computer network, then the data set and/or instructions are transmitted along the non-TCP/IP communication channel at a step 34. Alternatively, if the data set and/or instructions are not optimized for transmission along the non-TCP/IP communication channel of the computer network, then the data set and/or instructions are transmitted along a primary TCP/IP communication channel at a step 36. After steps 34 and 36, the method 26 ends at a step 38.

In accordance with the description herein, technical benefits and effects of this disclosure include systems and methods for transmitting data sets and/or instructions between a first computer and a second computer of a computer network along a primary TCP/IP communication channel and/or a non-TCP/IP communication channel of the computer network, maximizing efficiencies therein, including increasing the bandwidth available for communications and/or increasing processing speeds and/or increasing throughput, etc.

Advantages, benefits, improvements, and solutions, etc. have been described herein with regard to specific embodiments. Furthermore, connecting lines shown in the various figures contained herein are intended to represent exemplary functional relationships and/or physical couplings between the various elements. It should be noted that many additional and/or alternative functional relationships or physical connections may be present in a practical system. However, the advantages, benefits, improvements, solutions, etc., and any elements that may cause any advantage, benefit, improvement, solution, etc. to occur or become more pronounced are not to be construed as critical, essential, or required elements or features of this disclosure.

The scope of this disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one, and that reference to an item in the singular may also include the item in the plural, and vice-versa. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching may be used throughout the figures to denote different parts, but not necessarily to denote the same or different materials. Like depictions and numerals also generally represent like elements.

The steps recited in any of the method or process descriptions may be executed in any order and are not necessarily limited to the order presented. Furthermore, any reference to singular elements, embodiments, and/or steps includes plurals thereof, and any reference to more than one element, embodiment, and/or step may include a singular one thereof. Elements and steps in the figures are illustrated for simplicity and clarity and have not necessarily been rendered according to any particular sequence. For example, steps that may be performed concurrently or in different order are only illustrated in the figures to help to improve understanding of embodiments of the present, representative disclosure.

Any reference to attached, connected, fixed, or the like may include full, partial, permanent, removable, temporary and/or any other possible attachment option. Additionally, any reference to without contact (or similar phrases) may also include reduced contact or minimal contact. Surface shading lines may be used throughout the figures to denote different areas or parts, but not necessarily to denote the same or different materials. In some cases, reference coordinates may or may not be specific to each figure.

Apparatus, methods, and systems are provided herein. In the detailed description herein, references to “one embodiment,” “an embodiment,” “various embodiments,” etc., indicate that the embodiment described may include a particular characteristic, feature, or structure, but every embodiment may not necessarily include this particular characteristic, feature, or structure. Moreover, such phrases may not necessarily refer to the same embodiment. Further, when a particular characteristic, feature, or structure is described in connection with an embodiment, it is submitted that it is within the knowledge of one skilled in the art to affect such characteristic, feature, or structure in connection with other embodiments, whether or not explicitly described. After reading the description, it will be apparent to one skilled in the relevant art(s) how to implement this disclosure in alternative embodiments.

Furthermore, no component, element, or method step in the present disclosure is intended to be dedicated to the public regardless of whether the component, element, or method step is explicitly recited in the claims. No claim element is intended to invoke 35 U.S.C. § 112(f) unless the element is expressly recited using the phrase “means for.” As used herein, the terms “comprises,” “comprising,” or any other variation thereof, are intended to cover a non-exclusive inclusion, such that an apparatus, article, method, or process that comprises a list of elements does not include only those elements, but it may also include other elements not expressly listed or inherent to such apparatus, article, method, or process.

What is claimed is:

1. A computer network having multiple communication channels, comprising:
a first computer;
a second computer in bi-directional communication with the first computer through a TCP/IP communication channel and through a non-TCP/IP communication channel;
wherein the first computer and the second computer transmit a first data set and first instructions along the primary TCP/IP communication channel; and
wherein the first computer and the second computer transmit a second data set and second instructions along the non-TCP/IP communication channel.

2. The computer network of claim 1, wherein the first computer and the second computer simultaneously transmit the first data set and the first instructions along the primary TCP/IP communication channel and the second data set and the second instructions along the non-TCP/IP communication channel.

3. The computer network of claim 1, wherein transmission along the non-TCP/IP communication channel is block-oriented.

4. The computer network of claim 1, wherein the non-TCP/IP communication channel comprises a universal serial bus (USB) connection.

5. The computer network of claim 1, wherein the non-TCP/IP communication channel comprises a peripheral component interconnect express (PCIe) connection.

6. The computer network of claim 1, wherein transmission along the non-TCP/IP communication channel comprises a higher throughput than transmission along the primary TCP/IP communication channel.

7. The computer network of claim 1, wherein transmission along the non-TCP/IP communication channel comprises a lower latency than transmission along the primary TCP/IP communication channel.

8. The computer network of claim 1, wherein at least one of the first computer and the second computer utilize direct memory access over the non-TCP/IP communication channel.

9. The computer network of claim 1, wherein transmission along at least one of the primary TCP/IP communication channel and the non-TCP/IP communication channel is unicast.

10. The computer network of claim 1, wherein transmission along the non-TCP/IP communication channel is broadcast.

11. The computer network of claim 1, wherein transmission along the non-TCP/IP communication channel is multicast.

12. A computer-implemented method of processing information in computer network having multiple communication channels, comprising:
receiving a data set and instructions for transmission between a first computer and a second computer;
determining whether to transmit the data set and instructions between a first computer and a second computer along a primary TCP/IP communication channel or a non-TCP/IP communication channel; and
transmitting the data set and instructions between the first computer and the second computer along the primary TCP/IP communication channel or the non-TCP/IP communication channel in accordance with the determination.

13. The computer-implemented method of processing information of claim 12, wherein transmitting the data set and instructions between the first computer and the second computer further comprises transmitting the data set and instructions between the first computer and the second computer along the primary TCP/IP communication channel and the non-TCP/IP communication channel simultaneously.

14. The computer-implemented method of processing information of claim 12, wherein communication along the non-TCP/IP communication channel is block-oriented.

15. The computer-implemented method of processing information of claim 12, wherein the non-TCP/IP communication channel comprises a universal serial bus (USB) connection.

16. The computer-implemented method of processing information of claim 12, wherein the non-TCP/IP communication channel comprises a periphery component interconnect express (PCIe) connection.

17. The computer-implemented method of processing information of claim 12, further comprising:
utilizing direct memory access at the first computer or second computer over the non-TCP/IP communication channel.

18. A non-transitory computer-readable medium embodying program code executable in at least one computing device, the program code, when executed by the at least one computing device, being configured to cause the at least one computing device to at least:
receive a data set and instructions for transmission between a first computer and a second computer;
determine whether to transmit the data set and instructions between the first computer and the second computer along a primary TCP/IP communication channel or along a non-TCP/IP communication channel; and
transmit the data set and instructions between the first computer and the second computer along the primary TCP/IP communication channel or the non-TCP/IP communication channel in accordance with the determination.

19. The non-transitory computer-readable medium of claim 18, wherein the programming code is further configured to transmit the data set and the instructions between the first computer and the second computer along the primary TCP/IP communication channel and the non-TCP/IP communication channel simultaneously.

20. The non-transitory computer-readable medium of claim 18, wherein the non-TCP/IP communication channel comprises at least one of universal serial bus (USB) connection and a periphery component interconnect express (PCIe) connection.
